(19) United States
(12) Patent Application Publication
(10) Pub. No.: US 2017/0132588 A1
(43) Pub. Date: May 11, 2017

(54) Electronic Payment System and Relative Method

(71) Applicant: Francesco Ricci, Santarcangelo di Romagna (IT)

(72) Inventor: Francesco Ricci, Santarcangelo di Romagna (IT)

(21) Appl. No.: 15/323,187

(22) PCT Filed: Jun. 29, 2015
(86) PCT No.: PCT/IB2015/054865

§ 371 Date: Dec. 30, 2016

(30) Foreign Application Priority Data
Jul. 1, 2014 (IT) RN2014A000026

(51) Int. Cl. G06Q 20/10; H04L 29/06; G06Q 20/32

(52) U.S. Cl. CPC G06Q 20/10; G06Q 20/3278; G06Q 20/3276; G06Q 20/325; H04L 63/083

(57) ABSTRACT

This invention concerns a payment method carried out using fixed or mobile terminals. The invention takes place through a particular exchange of information between two devices. A specialized software installed on the equipments in order to enable the execution of the method.

### FIELD APPLICATION OF THE INVENTION

Carrying out payments easily and fast may seem a daily banality. In this case, the use of credit or debit cards or similar methods should seem like the most appropriate way. In spite of this, it yet happens many people still prefer the use of cash money for their purchases: the use of cash money, once again, reveals to be the simplest, most convenient, fastest, most practical and, privacy respectful, way. In the latter case, national and international interbank circuits, often, transmit payment data and information of each user to specialized marketing companies. The activity above described, means mapping of the user's daily life. This invention aims to create a valid alternative to the employment of cash money, yet maintaining all those features that make it, unique.

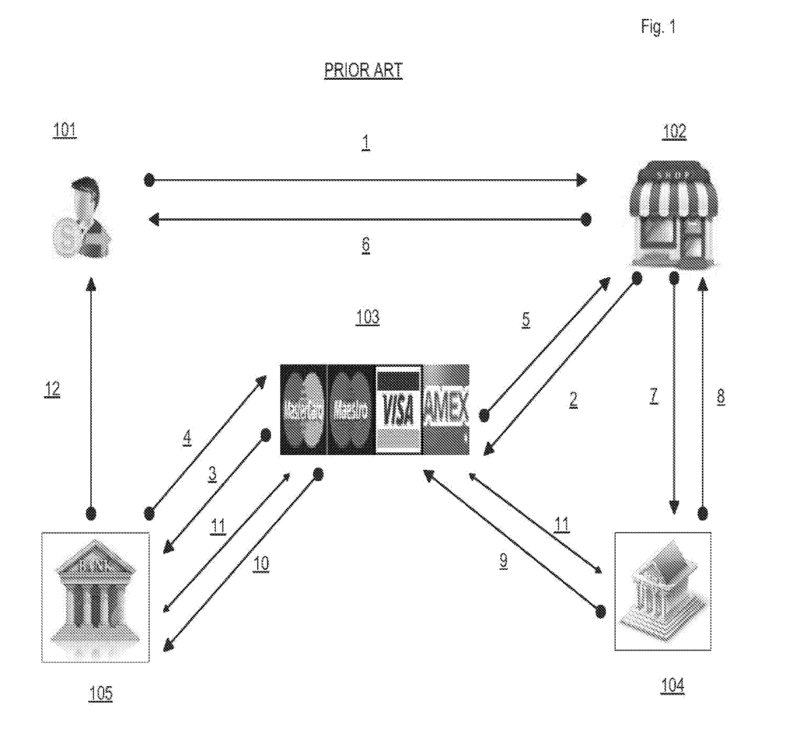

In general, the payment methods available on the market consist in the realization of a system in which the user on one side and the merchant on the other side, delegate to third parties to verify the correctness of the transaction. The third party is the interbank circuit and/or international circuits that manage debit or credit cards. This third party provides the confirmation and certification about the validity and guarantee of the contract or agreement that the customer and merchant have achieved. In FIG. 1, the customer (101) pays (1) the supplier (102) using its credit card. The receiver's POS (102), transmits (2) the credit card data and the transaction amount to the credit cards network (103) which sends them (3), to the card issuer (105) in order to obtain the authorization (4) by controlling the card validity and fund availability. If approved, the POS/receiver (102) receives (5) the authorization and (102) prints (6) the receipt that (101), the customer, has to sign or confirm with its own PIN. The POS/receiver (102) transmits (7) the information on the transaction for the acquirer's Bank (104) that manages the POS. (104) pays (8) to (102) the net amount of the occurred transaction with (101). At a later stage, in the phase of reconciliation or of compensation of the flows between the Acquirer Bank (104) and the Issuer Bank (105), the money amounts of the compensation (11) necessary to obtain the givehave balance with the credit cards circuit manager (103) are determined. Finally, (105) charges (12) the purchase amount on the payer's account (101).

FIG. 1 shows that each participant interacts with trusted known partners—especially the receiver, who pays attention to the authorizations given by the credit cards circuits. Acquirer Bank and Issuer Bank do not have direct relationships, but they interact through the mediation of the credit cards circuit. The mediation, as we know, represents a cost for the infrastructure that has to be maintained and supported and, therefore the users have to pay adequate commissions at the credit cards circuits.

### INVENTION SUMMARY

In absence of the third mediator, the invention implements instantaneously, payments and financial transactions in a safe way, through a particular sequence and exchange of information between the customer, merchant and the respective banks, which occur in real time. Basically, all the logical controls of the operation take place in a distributed way, directly in the place where the dealing has occurred. This becomes possible by using the latest technologies available on the market. The invention finds in SEPA the infrastructure necessary to manage the above-mentioned flows (SEPA for the Euro area allows both massive payments and, single payments, in compliance with the ISO 20022 regulation). The invention foresees the certification to be exercised by the two involved parties that, as a result of the ciphered information exchange—SSL, mutually confirm the payment and its favorable outcome. The person skilled in the art, will agree upon the simply user experience, speed and convenience of the application.

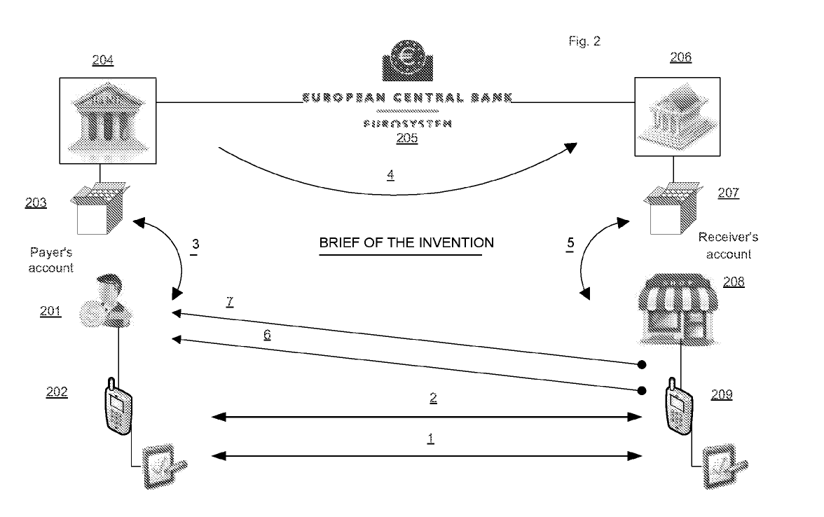

FIG. 2 represents a simplified diagram of the several functions of this method. The payment operation is made through the exchange of information between the receiver's terminals (208) and the payer's terminals (201). This exchange can occur by using, among the most known, NFC, RFID, WiFi, Bluetooth, and (1) consists in synchronizing the devices in order to obtain the connection that will be then followed by the information exchange (2): company information, description of the sold goods, price, respective IBAN codes. As a result, the device (202) of the customer (201) suitable for the online payments is connected (3) with its current account (203), where (202) forwards the data concerning the purchase, the money amount to be paid and the IBAN code corresponding to the receiver's current account.

Subsequently, in order to complete and guarantee the transaction, the customer inserts in its own device the PIN code, or the OTP (On Time Password) code earlier received from its bank or, as a further alternative, validates the execution of the payment, inserting its biometric data, to (204), that executes (4) the payment to the receiver (208) on its bank (206) on the current account (207).

The POS device, or the receiver (209) is connected (5) to (207) and controls the new bank statement in order to verify the payment outcome by the customer at its favor. In addition, (208) verifies the correctness of the transaction, directly concerning the goods just sold. Upon reception of the payment, the POS (209) prints (6) the payment receipt, and the receiver (208) delivers (7) the sold goods, to the customer (201).

### DETAILED DESCRIPTION AND REALIZATION OF THE INVENTION

This invention is addressed to a system that allows performing a new method to execute payments, micropayments for replacing the cash money. Through the following diagrams and charts, the invention is shown in its best possible solution. These example representations, sufficiently, describe the invention so that the person skilled in the art can easily put it into the practice. Therefore, the detailed representation is given as the preferred illustration, but this does not imply any limitation concerning this purpose: it is specifying, instead, that any variation: logical, mechanical can be realized without departing from the protection given by this patent application. The expert will also be able to appreciate how the invention can be implemented like a computer software, process system, and as a method it can be entirely implemented as a software, a hardware application or as a mixture of software and hardware applications.

Coming to the practical application, the involved mobile devices/terminals can use any type of electronic communication means or wireless platforms, including GSM, GPRS, UMTS, LTE, WiMAX, Bluetooth, WiFi and also barcode systems, QR codes, IrDA, RFID, NFC the same are all well-known, widely spread and normally used with mobile phones or smartphones. The here considered system can use the so-called circuit switching transmissions or packet switching transmissions.

The method, according to the invention, is aiming mainly to avoid the employment of cash money, yet maintaining all its features of speed and ease of usability. The system can also manage any payment or, financial service, post service, bank service, value added services (VAS). The system operation is based on a different concept and approach than the current payment systems, such as Credit Cards, which need a third party organization of certification for the execution of an electronic payment. In order to work, these systems need approval by a third party certification organism. In few words, in order to execute the payment, the receiver and the payer require to the third part to certify about the accuracy and certainty of the transaction, the third part supervises the correctness of the operation, with its confirmation. Subsequently, the merchant receives the notice that within few days he or she will receive the money amount of the sale on his or her current account, while the customer is informed that a debit on its credit card has been generated and it will be consequently debited on its current account.

In this case, for the supplied service by the third certifier, payer and receiver, pay commissions for the just completed transaction according to earlier agreements. Contrary to the currently used techniques, the invention allows a payment in real time through the SEPA system, or similar ones; where, the customer's and merchant's, current accounts are able to supply and/or receive financial transactions, in real time.

The SEPA system, considered in this invention, demonstrates to have the technological ability to support the operating scenario proposed by the applicant. Anyway, it is known that there are systems equivalent to SEPA with same or similar characteristics that act in different currency areas. Therefore, we believe that the patented system and method claimed may find correspondence and possibility of application also with SEPA equivalent systems.

The SEPA system (Single European Payments Area) is the direct evolution of the TARGET2 system (Trans-European Automated Real-time-Gross-Settlement 2). The SEPA system allows to carry out transactions/operations between issuer and beneficiary, both single that massive. The same are susceptible to intermediate steps or so-called Clearing House, where the processes of reconciliation between banks, concerning the relative active and passive assets, occur. This allows obtaining a synthetic report and a unique final payment between bank and bank in an automated way (ACH—Automated Clearing House). In Europe, the European Bank Association EBA has developed an automated system, involving all the participant banks, called STEP2, in particular the PEACH (Pan European Automated Clearing House). As a harmonizing system for bank operations in the 33 participant countries SEPA, has permitted the creation of a sole area of payment, having common rules and protocols, that allows payments/transfers/dispositions called: SCT (SEPA Credit Transfer), SDD (SEPA Direct Debit) and SCF (SEPA Card Framework). Moreover, through standard procedures and within the proposed technological scenario, the user can also manage its device in order to obtain all the other useful information concerning its account balance and relative transactions. The device is therefore synchronized and connected to its account and it's ready to transfer money by executing bank transfers, in real time, in favour of other devices assigned to other subjects with the total absence of any third certifier.

The devised system is able to combine all the requested characteristics that make it easy and safe to use, including:

1. Privacy: Guaranteeing the contents and meaning of the communication to authorized people, only;

2. Integrity: Guaranteeing to the receiver that no falsification has occurred in the original message, generated by the user;

3. Authentication: Ensuring that all the parties involved in a communication are recognized with certainty;

4. Authorization: Guaranteeing that any entity enabled to carry out an operation, have the right to do it in the specific context;

5. No disclaim: Guaranteeing that in the transaction, neither the recipient nor the user can deny having participated in it;

6. Safety: Guaranteeing the impossibility of credit card frauds or the cloning of cards. The use of cash money is completely avoided;

7. Accessibility: Guaranteeing great savings for the users avoiding expenses or commissions related to credit cards circuits. Providing increase of financial transactions and permitting the availability of other cash activities to the bank system. The cash money that remains today in the users pockets will remain credited in the users bank accounts.

The device being set through the installation of standardized software systems or appropriate APPs to store (Plug-In)/applications for managing the device safely, consisting of a suitable combination of hashing algorithms, symmetric and asymmetric encryption algorithms, generation algorithms and memorization of keys encryption (On board key generation)

In addition to this level of safety that aims at a safe transfer of data, a further level of safety is expected for the access and authentication of the user. This procedure consists in inserting a PIN or OTP code and also inserting the biometrical data of the user, including for example: signature, iris, retina, face shape, ear shape, fingerprints, voice print, so that the user can access and organize all the possible financial transactions. The set and combination of these technical applications directly managed on the apparatus to allow safe and easily accessible services. This invention allows having a device that proves to be able to execute functions that, so far, have been specific only for cash payments.

The method of the invention permits the registered user to carry out, bank operations and financial services, in a simple and safe way, from one's own mobile device. The main purpose of this invention is to provide a unique software/APP that allows replacing the physical exchange of banknotes and cash money. Anyone who has a mobile terminal of second or third generation and a bank account can, in any moment, safely and in few, simple steps, carry out financial transactions by sending encrypted messages.

The invention includes an apparatus equipped with an APP that uses standard systems and plug-ins which allow to implement the following functions for the safety management: the generation of asymmetrical keys; PIN creation, modification and check; cryptography; decryption; digital signature. The system safely allows distinctive VAS services, as: banking, saving, financial, postal, trough sending encrypted messages.

The invention implements a method with the purpose of carrying out VAS services (distinctive VAS), where the user carries out communications between set devices as follows:

A) Subscription of a contract of bank current account in order to obtain the assignation of an IBAN code

B) Bank account enabled for online services

C) Installation of the software/APP on the apparatus

D) LOG procedure, to the system, by using an access account

E) Qualification procedure to be authorized at reading service and to the execution of payment orders.

F) Management of the passwords, enacting codes or biometrical data for the execution of the transactions

The above-mentioned functions are daily used. The person skilled in the art, is well aware of these systems and techniques, and knows how common the employment of these instruments is. Nowadays, each bank offers their customers, home banking services via desktop or via smartphone. The expert will also appreciate the innovative method in relation to different management of the information exchange. In particular, the operation of certification that the two parties guarantee each other in order to complete the operation in absence or in place of the certification of a third party, the credit cards circuit.

### DETAILED DESCRIPTION WITH THE DRAWINGS

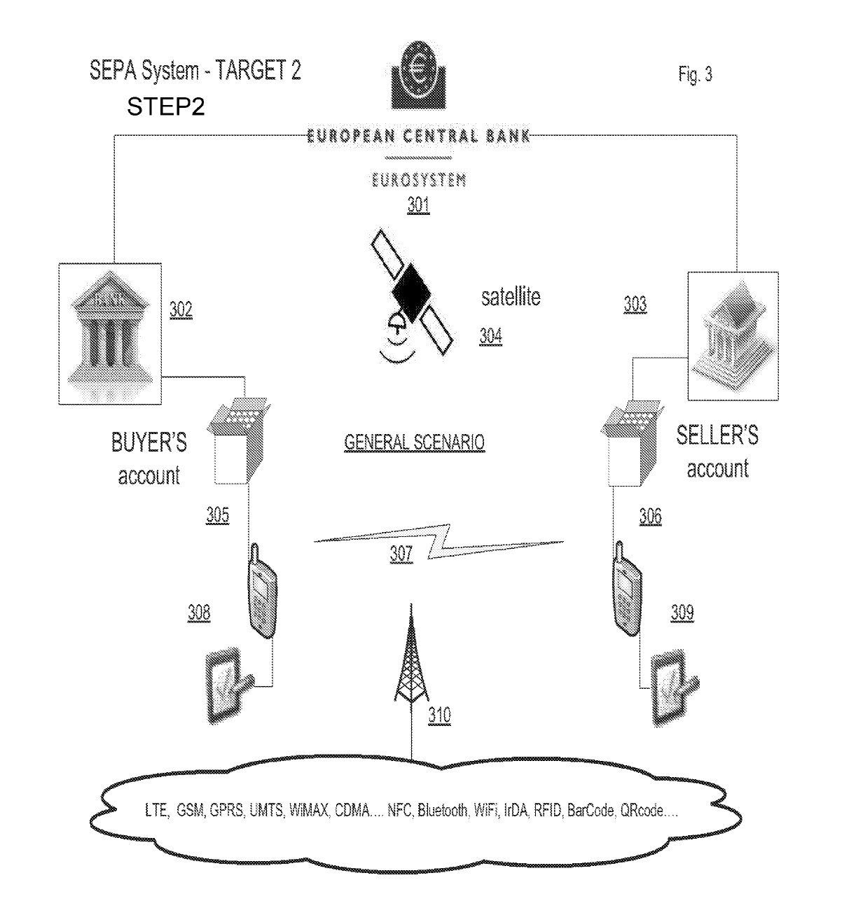

FIG. 3 shows the main intervention areas of the system and the general scenario, the involved parties and the relative infrastructures—SCENARIO.

In this case:

301—ECB Eurosystem/SEPA Network

302—Payer's bank

303—Receiver's bank

304—Satellite info/GPS

305—Payer's account

306—Receiver's account

307—Data exchange

308—Payer's device

309—Receiver's device

310—Networks

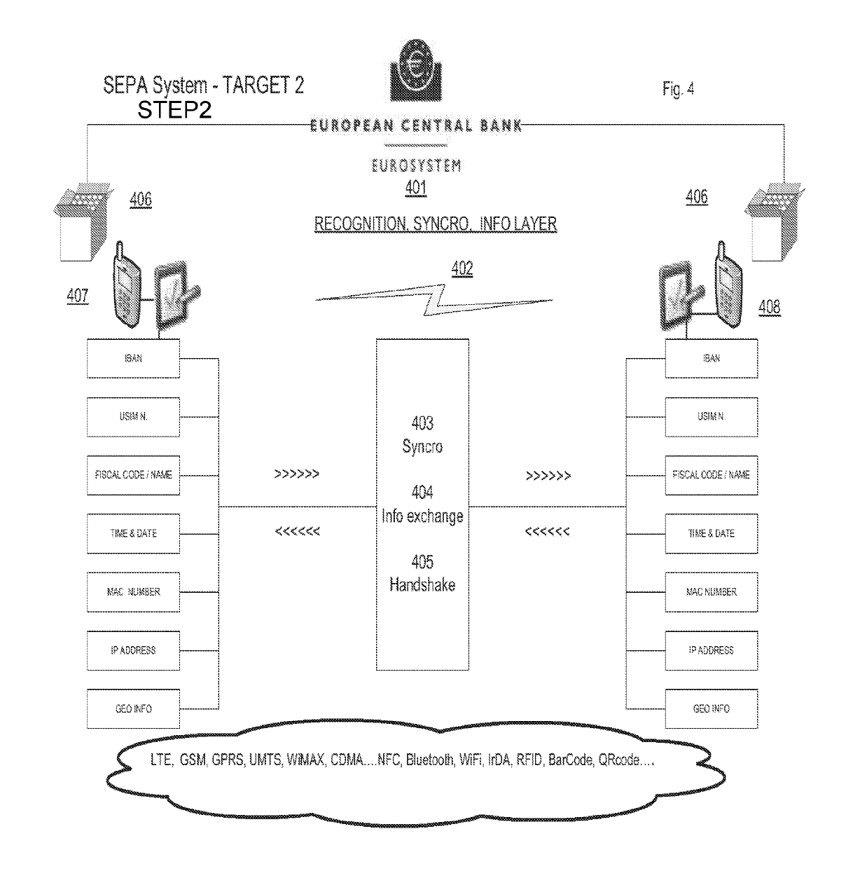

FIG. 4 represents all the steps of the information exchange and of the recognition between devices—RECOGNITION, SYNCRO, INFO LAYER

In this case:

401—ECB Eurosystem/SEPA Network

402—Transmissive manner

403—Synchronization between devices

404—Information exchange

405—Connection confirmation

406—Bank accounts

407—Payer's device

408—Receiver's device

407 and 408 select the transmission modality among NFC, RFID, Bluetooth, WiFi, IrDA, BarCode, QRcode, 402. Subsequently, they synchronize each other the devices by checking the position, date and time, trough the data network or telephone lines and through the GPS information in 403, which is followed by the information exchange; IBAN, USIM, Tax Code/Digital ID, MAC address, IP address to 404 in order to confirm the 405 connection between the devices.

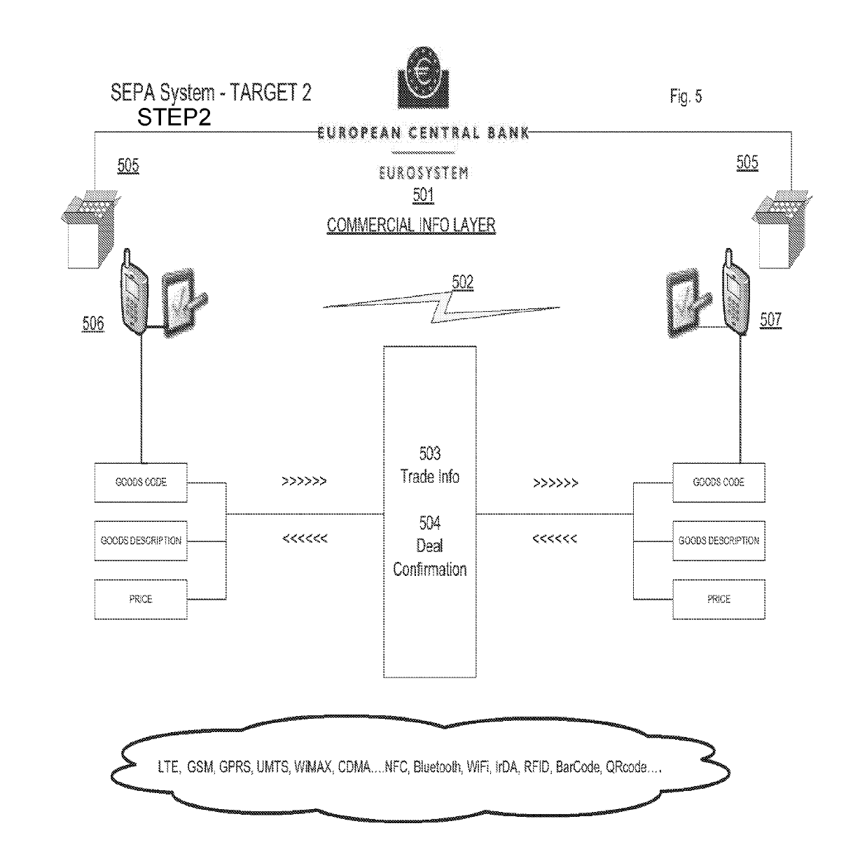

FIG. 5 represents the commercial information exchange between the devices in relation with the financial transaction between the parties—COMMERCIAL INFORMATION LAYER

In this case:

501—ECB Eurosystem/SEPA Network

502—Transmissive manner

503—Trade Information

504—Confirmation of Transaction

505—Bank accounts

506—Payer's device

507—Receiver's device

507 whilst maintains the transmissive modality 502, sends commercial information to 506, including; product code, description, price 503. 506 states that it has received information from 507 with 504

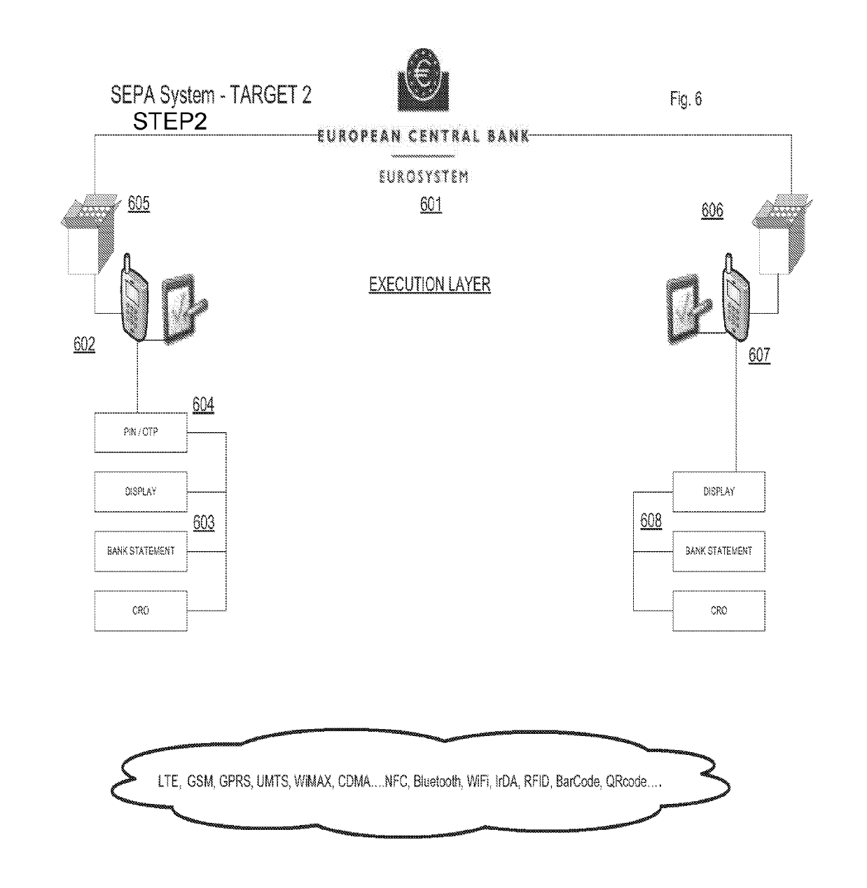

FIG. 6 represents the exchange, through data network and or telephone lines, of information between the devices and the respective bank accounts of the payer and of the receiver and describes the payment confirmation through PIN or OTP. It shows the reception and verification of the payment from the receiving party—EXECUTION LAYER

In this case:

601—ECB Eurosystem/SEPA Network

602—Payer's device

603—Payer's bank statement/Display/CRO

604—PIN/OTP/Biometric Data

605—Payer's account

606—Receiver's account

607—Receiver's device

608—Receiver's bank statement/display/CRO

While 602, is checking its bank statement on 603, through the device display, it connects to 605. From 605, 602, through the SEPA payment system, sends the order 601 towards 606, by confirming the funds transmission through PIN and/or OTP 604. 607, it connects to 606 and checks the payment corresponding to the goods purchased by 602.

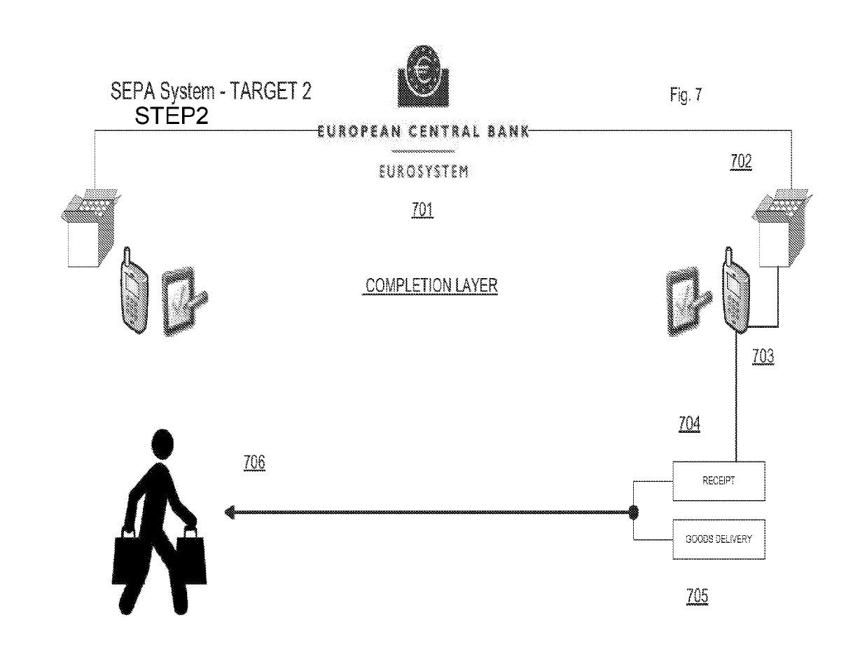

FIG. 7 represents the final stage of completion of the payment through emission of the receipt of sales and delivery of the sold goods. COMPLETION LAYER

In this case:

701—ECB Eurosystem /SEPA Network

702—Receiver's account

703—Receiver's POS

704—Receipt

705—Delivery

706—Purchase/payer

After the payment has been made by 706 through the SEPA system and 703 has checked the payment, 703 issues the payment receipt and delivers the purchased goods 704 705, to 706.

The actual condition of technology makes available a big distributed capacity of calculation on board of the devices, and it allows a big capacity of transportation on the telephone/data network. These performances allow SEPA, or similar systems, the real time information exchange between devices such as the ones described in the invention. In this way, the batch operations of reconciliation, which are carried out during the dead times of the day can be also executed in real time during the so-called rush hours, or they could be even avoided. Therefore, the system allows huge advantages in relation to the reduction of the costs of system management and maintenance, higher confidentiality, additional liquidity of cash to the bank system, elimination or substantial reduction of the commissions cost, safety for the user and system against frauds, comfort and an easy user experience.

For these reasons, we express our claims.

1-10. (canceled)

11. A system to carry out electronic payments, comprising:
a first device configured to exchange commercial data and information of identification with a second device, and further configured to remotely communicate with a first account associated with a first bank;
a second device configured to exchange commercial data and information of identification with respect to the first device, and further configured to remotely communicate with a second account associated with a second bank;
wherein the first device and second device are synchronized and configured for interconnection with each other;
wherein the first device is configured to immediately order payments to the first bank, on the basis of identification data and commercial details received from the second device;
wherein the first device is configured to immediately send funds from the first account to the second account;
wherein the first device is configured to receive confirmation of the payment from the second device, which is in turn configured to check the arrival of funds in the second account, wherein the funds are immediately made available upon arrival in the second account;
wherein the second device is configured to confirm payment reception to the first device, through one or more of: emission of a payment receipt; showing the received payment on a display; and sending a confirmation message.

12. The system of claim 11, wherein the first device and the second device are configured to exchange information of identification between one another, the information of identification chosen from among one or more of a group comprising: IBAN, Name, Digital ID, Tax code, telephone number, MAC address, IP address, geographical coordinates, date, and time.

13. The system of claim 12, wherein the first device and the second device are configured to exchange commercial details between one another, the commercial details selected from among one or more of a group comprising: product codes, product description, prices, extra costs, taxes (if due), CRO/Operation Reference Code.

14. The system of claim 13, wherein the first device and the second device are configured to mutually exchange information using one or more transmission technologies from a group comprising: NFC, RFID, WiFi, LTE, UMTS, GSM, WI-MAX, TCP/IP, Barcode, QrCode, IrDA, Bluetooth, and
wherein the first device and the second device are each equipped with a GPS sensor.

15. The system of claim 14, wherein the first device is configured to access the first bank account by using access information, and
wherein the first device is configured to confirm a payment order by selecting one or more of the following codes: PIN, OTP, biometrical data, logical sequences.

16. The system of claim 15, wherein the second device is configured to access the second bank account through login and password information, and
wherein the second device is configured to confirm the payment reception to the first device.

17. The system of claim 11, wherein the first bank associated with the first account and the second bank associated with the second account are linked via an interbank network, and
wherein the first device, the first bank, the second device and the second bank are configured to perform operations in real time from the interconnection of the first device and the second device with each other, to the confirming of payment reception to the first device, via the interbank network, a satellite system, one or more data exchange sessions, and one or more connection networks.

18. The system of claim 11, wherein each of the first device and the second device comprise equipment selected from one or more of a group comprising: a kiosk, a workstation, a personal computer, a desktop, a portable computer, a smartphone, a tablet.

19. The system of claim 18, wherein each of the first device and the second device are fitted with one or more displays, video cameras, and data transmission systems, configured to both operate on fixed networks and on mobile radio networks.

20. The system of claim 11, wherein each of the first device and the second device further comprise software installed thereon and executable by the respective device to generate user terminals, said terminals configured to enable user input of codes with respect to: identification of the parties, identification of the goods subject to the transaction, confirmation of the transaction, and execution of the transaction.

21. A method of carrying out electronic payments between a payer device and a merchant device, the method comprising:
synchronizing the payer device and the merchant device in association with a commercial transaction;
transmitting identification data and commercial details associated with the transaction from the merchant device to the payer device;
upon receiving the identification data and the commercial details, immediately ordering from the payer device payments to an associated first bank;
immediately sending funds from a first account associated with the payer and the first bank to a second account associated with the merchant;
detecting arrival of funds in the second account, wherein the funds are immediately made available; and
confirming payment reception to the payer device, in real time with respect to the commercial transaction, via one or more of: emission of a payment receipt from the merchant device; showing the received payment on a display of the payer device; and sending a confirmation message from the merchant device to the payer device.

22. A system for carrying out electronic payments, comprising:
means for exchanging identification data and commercial details between a payer device and a merchant device synchronized therewith, in real time association with a transaction;
means for immediately executing payment from a first bank account associated with the payer to a second bank account associated with the merchant, based on the exchanged identification data and commercial details, wherein funds associated with the payment are immediately made available to the merchant; and
means for confirming payment reception to the payer device.
